(19) United States
(12) Patent Application Publication
(10) Pub. No.: US 2011/0159811 A1
(43) Pub. Date: Jun. 30, 2011

(54) White Wireless Network

(76) Inventors: Jianglei Ma, Kanata (CA); Hang Zhang, Nepean (CA); Wen Tong, Ottawa (CA); Ming Jia, Ottawa (CA); Peiying Zhu, Kanata (CA)

(21) Appl. No.: 12/806,186

(22) Filed: Jul. 2, 2009

Related U.S. Application Data
(60) Provisional application No. 61/078,257, filed on Jul. 3, 2008.

(51) Int. Cl. H04W 40/00

(52) U.S. Cl. 455/39

(57) ABSTRACT

Aspects of the present invention provide a multi-band hybrid Gigabit wireless communication system which is enabled by a number of different complementary access technologies to realize ubiquitous hyper-connectivity, true broadband, seamless operation and low power consumption. The system is capable of serving fixed, nomadic and mobile scenarios. The multi-band wireless system is a low power wireless system which operates in different frequency bands covering the spectrum from radio wave to optical wave by making use of both regulated bandwidths and unregulated bandwidths. Using low power distributed antenna and low power indoor and outdoor antennas enables the use of unregulated bandwidths as well as regulated bandwidths as the low power nature of the signals reduces the possibility of interference with the regulated use of the signals.

### CROSS-REFERENCE TO RELATED APPLICATIONS

This is the first application filed for the present application.

### MICROFICHE APPENDIX

Not applicable.

### TECHNICAL FIELD

This application relates to wireless communication techniques in general, and to a technique of white wireless network, in particular.

### SUMMARY

Aspects and features of the present application will become apparent to those ordinarily skilled in the art upon review of the following description of specific embodiments of a white wireless network in conjunction with the accompanying drawing figures and appendices.

### DETAILED DESCRIPTION

This disclosure proposes a multi-band hybrid Gigabit wireless communication system which is enabled by a number of different complementary access technologies to realize ubiquitous hyper connectivity, true broadband, seamless operation, low power consumption. This system covers the fixed, nomadic and mobile scenarios.

This disclosure gives the solution to build a low power multi-band wireless system which operates in different frequency bands covering the spectrum from radio wave to optical wave by making use of the regulated bandwidths and an enormous amount of unregulated bandwidths.

In related art systems, the whole wireless network can be built based on a single RF frequency band for both indoor and outdoor. However it is difficult to provide Gigabit rate with low power assumption.

Specific elements or steps envisaged are:
1. White wireless network operate in multiple frequency bands ranging from microwave to optical wave. Each link (indoor/outdoor backhaul or indoor/outdoor link) can be optimized individually in different frequency band.
2. The same air-interface, for example OFDMA or SC-FDMA, can be applied to different frequency bands to allow the terminal device work in multiple frequency bands with the same frame structure, same modulation method and same base-band processing functions.
3. The indoor wireless link can be generated by white LED which can also be used for lighting.

Further details of embodiments can be found in the attached appendix A.

The above-described embodiments of the present application are intended to be examples only. Those of skill in the art may effect alterations, modifications and variations to the particular embodiments without departing from the scope of the application.

1. A method comprising:
transmitting a communication signal between a base station and a terminal located within a structure via one or more low power distributed antennas, at least one outdoor access point outside of the structure, at least one indoor access point inside of the structure, wherein the communication signal is transmitted on links between the base station and the terminal, in which the links include at least one radio frequency (RF) link, the at least one radio wave link including both regulated bands and unregulated bands.
